(19) United States
(12) Patent Application Publication
(10) Pub. No.: US 2024/0384891 A1
(43) Pub. Date: Nov. 21, 2024

(54) Electric Water Heater

(71) Applicants: Alexander ZOLDAN, Kiryat Motskin (IL); Michael GRENADER, Haifa (IL)

(72) Inventor: Michael GRENADER, Haifa (IL)

(21) Appl. No.: 17/999,888

(22) PCT Filed: May 26, 2020
(86) PCT No.: PCT/IL2020/050590

§ 371 Date: Nov. 25, 2022

(51) Int. Cl. F24H 9/1818; F24H 1/10; H05B 3/20

(52) U.S. Cl. CPC F24H 9/1818; F24H 1/103; H05B 3/20; H05B 2203/003; H05B 2203/021

(57) ABSTRACT

Field of technology: Water electric heaters with resistive heating elements immersed in water.

Problem to be solved: Increasing the heat-emitting surface, efficiency and power output of the heating element in order to minimize heat loss and optimize the operating temperature of the heating element immersed in water.

The essence of the invention: The resistive conductor of the heating element is made of a thin resistive tape (4), the perimeter of the cross-section of which exceeds mainly more than twice the perimeter of the cross-section of a round wire of equal cross-sectional area. The spiral from of tape 4 has a thermally conductive dielectric coating 5, is wound on a carcass of thin-walled cylindrical pipe 3 and forms, respectively, the external and internal heat-emitting surfaces of the heater. On both sides of the heat-emitting surfaces of the heater, gaps 11 are formed for the flow of the heated fluid. The heater may comprise several such cylindrical heating elements concentrically arranged in one another.

Alternative solutions: The electric heater may contain flat heating elements with a thin resistive tape, curved in the form of a sinusoid, or in the form of an Archimedes spiral.

Cylindrical and flat spiral heating elements can be formed from a flattened tubular shell into which a thin resistive tape with an insulating coating is pressed.

### AREA OF ENGINEERING

The invention relates to electric water heaters with resistive heating elements, which are located inside the heater and immersed into water.

### PRECEDING LEVEL OF ENGINEERING

A tubular electric heater (GB1360334) is known, in which a heating spiral made of a round resistive conductor is coated with insulating material and placed in a groove between two cylindrical pipes of the heater housing.

However, such a tubular electric heater has the following significant disadvantages:
The heat-emitting ability of the heater is insufficient, since the heat-emitting surface of the round resistive conductor is located only on the periphery of the conductor and is minimal when its cross section is round,
Due to the deficit of the heat-emitting surface, the heat efficiency of the heater is insufficient. This is due to the fact that with the passage of current, the entire cross section of the resistive conductor is heated. In this case, only a part of the energy is usefully radiated through the outer surface of the conductor (which is minimal with its round cross section), and the rest of the energy is spent on overheating the central part of the round cross section of the resistive conductor (to a temperature of 700-800° C.);
The heater has significant heat loss and increased inertia at a high temperature of the spiral, due to deterioration in thermal conductivity caused by the cavitation at the boundary between water and the shell surface of the resistive conductor. This is due to the fact that the rate of energy transfer to water and the amount of heat losses depend on the temperature of the heat-radiating surface of the heater. The extremum of the heat transfer rate corresponds to the optimum temperature ≈156° C. Overheating of the surface above this temperature generates heat-insulating gas bubbles (cavitation) and a decrease in heat transfer. Moreover, the higher the temperature, the faster the heat transfer to the water decreases, while the inertia and spurious heat transfer into the environment increase. Due to inertia, such a heater has a limited scope of use only as a water heater immersed in non-flowing water.

Also an electric water heater (U.S. Pat. No. 3,898,428) is known comprising a cartridge heating element with a cylindrical spiral made of a round in cross section resistive conductor located under the shell of the heating element. The cartridge of the heating element is placed in a tubular housing, the inner side of which has a spiral-corrugated surface. In this water heater, compared with the above counterparts, the sequential removal of heat from the surface of the heating element is somewhat improved due to the turbulence created by the spiral-corrugated surface. In addition, it is possible to heat a small amount of liquid to a high temperature, due to the presence of a power regulator and two operating modes. However, it also has a number of significant drawbacks, namely:
The heat efficiency of the heater is insufficient, since the round cross section of the resistive conductor creates a deficit of its heat-radiating surface, which is located only on the periphery of the circle. Therefore, a significant part of the energy is spent on overheating the central part of the cross section of the resistive conductor. In addition, part of the heat-radiating surface of the spiral turns is facing each other, resulting in the overheating of the spiral to a high temperature;
The heat-radiating ability of the heater is insufficient, since the heat-emitting surface of the tubular shell is located only on the outside of the spiral. Radiation from the inside of the spiral is not useful, and only overheats the inner tube of the heater
The heater has additional heat loss at a high temperature of the spiral, due to deterioration of thermal conductivity, caused by a cavitation at the boundary between water and the heater shell surface.
Due to the lack of power output, the heater cannot function as a flow heater for a long time. Therefore, it has a limited scope, mainly in heated water circulation systems, to maintain its temperature. In addition, such heaters are more expensive and difficult to manufacture.

### DISCLOSURE OF THE APPLIED INVENTION

The basis of the invention is the task of creating such an electric water heater where the heating element and the resistive conductor would be designed and arranged relative to each other in a way that to increase the heat-radiating surface, optimize the operating temperature, minimize heat losses, maximize the heat transfer rate of the heating element, and thereby increase the heater's thermal efficiency.

The problem is solved in that the resistive conductor of the heating element is made of a thin resistive tape, the cross-sectional perimeter of which exceeds the cross-sectional perimeter of a round wire of the same cross-sectional area, and the tape width exceeds its thickness, predominantly, more than ten times. Both wide sides of the resistive tape form two heat-radiating surfaces. The heating element is placed in the electric heater housing in such a way, that slotted gaps for the flow of the heated liquid are formed on both sides of its heat-radiating surfaces. The ratio between the width of the heat-radiating surface of the heating element and the slit size (height) of each gap for the flow of the heated liquid is selected from the condition of ensuring the optimal temperature head and thermal conductivity, at which the rate of heat transfer to the heated liquid will be maximal.

The heating element, fulfillment with a thin resistive tape, has more than doubles heat-radiating surface, compare to a round wire of equal cross-sectional area. This reduces the specific load and the heating temperature on its surface to the optimal values corresponding to the extremum rate of the heat transfer to the heated liquid. Since there is no massive central part in the cross-section of the thin tape, it is not being overheated. In this case, all the energy is transferred to the heated liquid circulating in the gaps formed on both sides of the heat-radiating surface of the heating element. At the same time, cavitation is decreased and the heat transfer rate increases is maximized, which reduces the heat loss of the heating element.

The formation of slotted gaps for the flow of the heated liquid adjacent to the heating element from two wide sides is optimizes the heat transfer conditions. On the one hand, the heat-radiating surfaces of the heating element and their high thermal conductivity are used to the maximum. On the other hand, by selecting the height of the gaps, it is possible to provide an optimal heat transfer mode. Given that the thermal conductivity of the heating element is much higher than the thermal conductivity of water, in a thin layer of water adjacent to the heat-radiating surface of the heating element the heat transfer rate is maximum. Therefore, for a heater of a certain capacity, a ratio between the heat-radiating surface width of the heating element and the height of the gap adjacent to it for the flow of the heated liquid, can be chosen that is meets the conditions for optimizing of the temperature pressure and achieving the maximum heat transfer rate.

Thus, the combination of the above features in the proposed water heater design provides a solution to the problem posed as the basis of the invention, namely: increasing the heat-radiating surface and optimizing the operating temperature of the heating element, maximizing the rate of heat transfer and reducing the inertia of the heater, minimizing heat losses of the heating element and the cavitation process. All this ensures the high thermal efficiency of such water heaters.

The fulfillment of the heating element from resistive tape as the rolled with the gaps, formed on both sides of its heat-radiating surface, allows to create efficient water heaters, as either volumetric or flat compact structures. The lowered temperature of the heater allows the usage of cheap materials (for example, enamel, PTFE and fiberglass) as an insulating coating and simplifies the heaters manufacturing technology. This reduces the manufacturing cost of such heaters and expands their application scope.

In one variation of the electric heater, its carcass is formed of a thin-walled cylindrical pipe, on which a cylindrical spiral from a thin resistive tape of the required length is wound. In this case, the opposite wide sides of the resistive tape adjacent to the cylindrical pipe form the external and internal heat-radiating surfaces of the cylindrical heating element. The resistive tape has a coating (for example, enamel) that insulates it from the heated liquid. This provides a direct contact of the heating element with the heated liquid (without the use of a protective tubular shell), which reduces the manufacturing cost of such heaters and further reduces heat losses.

In another variation of the electric heater, the heating element comprises a thin resistive tape of the required length, curved in the shape of a rectangular sinusoid (meander) and placed in a flat sectioning housing. The heating element is placed in sections of the electric heater housing in such a way that wave-like gaps for liquid flow are adjacent to both heat-radiating sides of the resistive tape. This ensures a direct contact of the resistive tape with the heated liquid and further reduction in heat losses. The flat shape allows creation of the high-power compact flow heaters.

In yet another variation of the electric heater, the heating element comprises a flattened tubular shell into which a thin resistive tape with an insulating coating is pressed and which is folded in a shape of a double Archimedes spiral. A spiral gap for the fluid flow is formed between the heat-emitting sides of adjacent turns of the spiral heating element.

The oblate cross-sectional shape of the tubular shell closely matches the cross-sectional shape of the resistive tape, which ensures optimal conditions for heat transfer from its opposite wide sides to the external and internal heat-radiating side of the tubular spiral. These features expand the technological capabilities and the scope of use of such heaters. At the same time, the compactness of the heating element, its increased efficiency and power output, is maintained.

### THE BRIEF DESCRIPTION OF THE DRAWINGS

The invention is illustrated by drawings, where:

FIG. 1—depicts a variant of an electric heater with two concentrically mounted cylindrical heating elements, a vertical section:

FIG. 2—depicts a variant of an electric heater with two pairs of concentrically mounted cylindrical heating elements, a vertical section;

FIG. 3—depicts a variant of an electric heater with a flat sinusoidal heating element, a vertical section;

FIG. 4—is a section IV-IV in FIG. 3:

FIG. 5—is a bottom view of a variant of an electric heater with two flat sinusoidal heating elements;

FIG. 6—depicts a variant of an electric heater with a disk spiral heating element, horizontal section;

FIG. 7—is a section VII-VII in FIG. 6;

FIG. 8—is a side view of a variant of an electric heater with two disk spiral heating elements, a vertical section.

### THE DESCRIPTION OF VERSIONS OF THE INVENTION

The electric heater embodiment shown in FIG. 1, consists of two cylindrical heating elements 1 and 2, concentrically placed between each other. Each heating element comprises a carcass of a thin-walled cylindrical pipe 3, on which a cylindrical spiral of thin resistive tape 4 is wound. The tape 4 has an insulating coating 5, made predominantly of heat-conducting dielectric enamel. The outer and inner side of the coils of the tape spiral 4, adjacent to the cylindrical pipe 3 with its wide sides, forms, respectively, the external and internal heat-radiating surfaces of the heater. The ends of the spiral tapes from the side of one end of the cylindrical heating elements 1 and 2 are connected, respectively, with contact cleats 6 and 7, for connecting the heating elements to a power source. The ends of the spiral tapes from the side of the second ends of the cylindrical heating elements 1 and 2 are interconnected by a jumper 8, isolated from the heated fluid. Contact cleats 6 and 7 are placed out to the cover 9 of the cylindrical housing 10.

Resistive spiral 4 is made of thin resistive tape to increase the heat efficiency of the heater. Moreover, the perimeter of the section of the tape exceeds more than twice the perimeter of the cross section of a round wire with equal sectional area, that is, the width of the tape exceeds its thickness by more than ten times. In practice, thin tapes with an even larger aspect ratio can be used. For example, a 3 kW heater can be equipped with a tape with a cross-sectional area of 7×0.06 mm, in which the ratio of width to thickness is more than 100:1. This provides a six-fold increase in the heat-radiating surface of such a tape, compared with a round conductor of equal cross-sectional area.

The FIG. 1 shows a variant of the instantaneous water heater, in which the inner cylindrical heating element 2 is concentrically placed in the outer cylindrical heating element 1. The heating elements 1 and 2 are installed in the cylindrical housing 10 with the formation of cylindrical gaps 11 for the liquid flow between them, as well as between the external heating element 1 and the housing 10. The external heating element 1 is pressed against the lower end of the cylindrical housing 10 and has a gap for liquid flow at the upper end of the housing 10. The internal heating element 2 is pressed against the upper end of the cylindrical housing 10 and has a gap for liquid flow at the lower end of the housing 10. In front of the external heating element 1 there is a branch pipe 12 for water inlet, and in the center of the lower end of the cylindrical housing 10 there is a branch pipe 13 for water outlet. A pipe 14 connected concentrically in the internal heating element 2, is connected to the branch pipe 13. Between the upper end of the housing 10 and the upper end of the pipe 14 there is a gap for liquid flow.

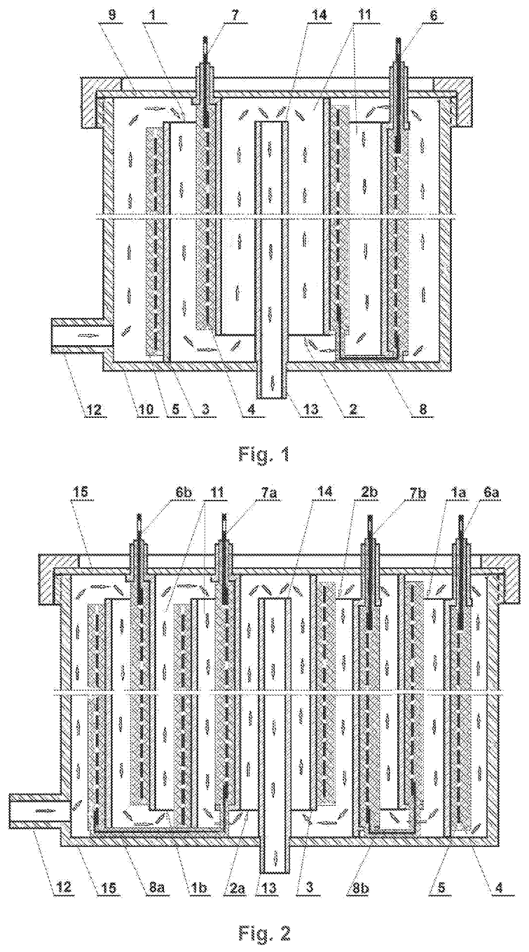

The FIG. 2 presents a variant of the instantaneous water heater, which contains two pairs 1a, 2a and 1b. 2b of cylindrical heating elements concentrically placed in the housing 15. Resistive tapes 4 of these heating elements are connected with each other, respectively, by jumpers 8a and 8b. As the diameters decrease, the external heating elements 1a and 1b are concentrically placed in the direct order, and the internal heating elements 2a and 2b are concentrically placed in the reverse order.

Moreover, the diameters dimensions of cylindrical heating elements 1a. 2a and 1b, 2b are selected according to the condition of the equality between the sums of diameters of the cylinders of the connected pairs 1a, 2a and 1b, 2b. Contact cleats 6a, 7a and 6b, 7c are placed out to the cover 16 of the cylindrical housing 15. In the lower part of the housing 15 there is a branch pipe 11 for water inlet, and in the center of the lower end of the housing 15 there is a branch pipe 12 for water outlet, connected to the pipe 14 for water flow.

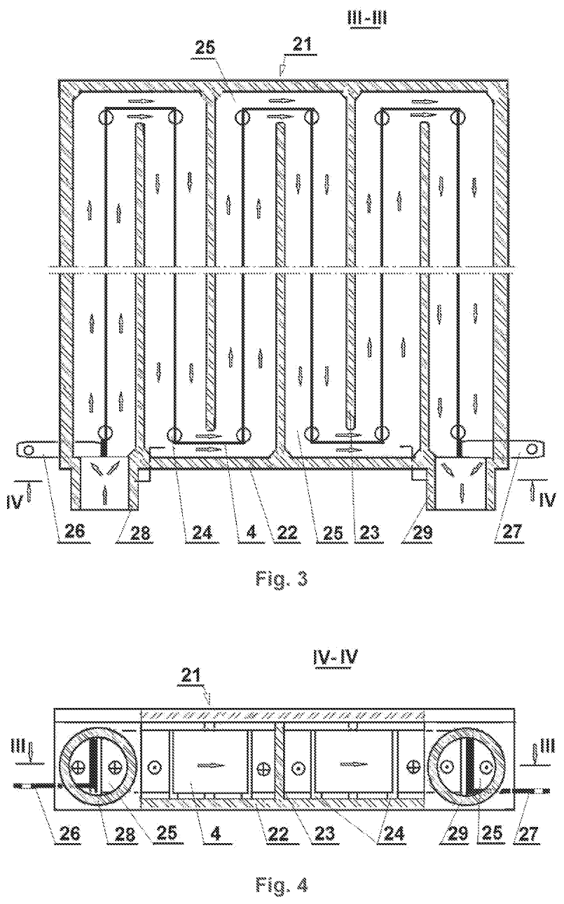

FIGS. 3 and 4 show a variant of an electric heater with a flat sinusoidal heating element 21, which is formed from a thin resistive tape 4 curved in the form of a sinusoid, mainly a rectangular sinusoid (meander). The housing 22 is divided into longitudinal sections by means of partitions 23 in which passages are made for the flow of liquid. The resistive element 21 is located in the sectioning housing 22 and fixed by means of clamps 24 in such a way that wave-shaped gaps 25 for the liquid flow are adjacent to its both heat-radiating sides. The ends of the resistive tape 4 are connected to the contact cleats 26 and 27, located outside, respectively, the first and last sections. The branch pipes 28 and 29 for water inlet and outlet are placed, respectively, before the first and last sections of the housing 22.

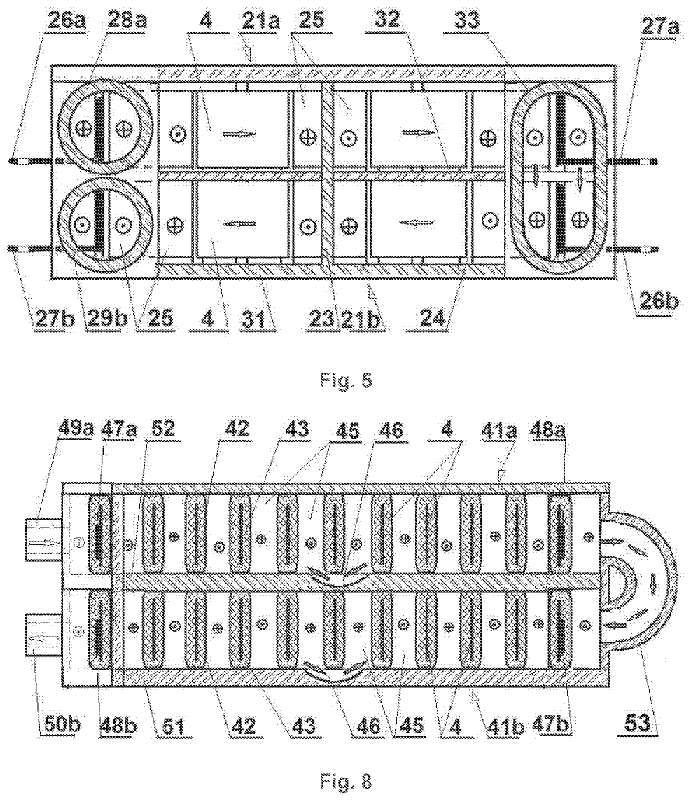

The FIG. 5 presents a variant of a two-tier electric heater with flat sinusoidal heating elements 21a and 21b, bottom view. The front view of the two-tier electric heater is similar to that shown in FIG. 3. The heating elements 21a and 21b are placed in the housing 31 and are separated by an inter-level partition 32. The water outlet section of the heating element 21a is connected to the water inlet section of the heating element 21b by a connecting branch pipe 33.

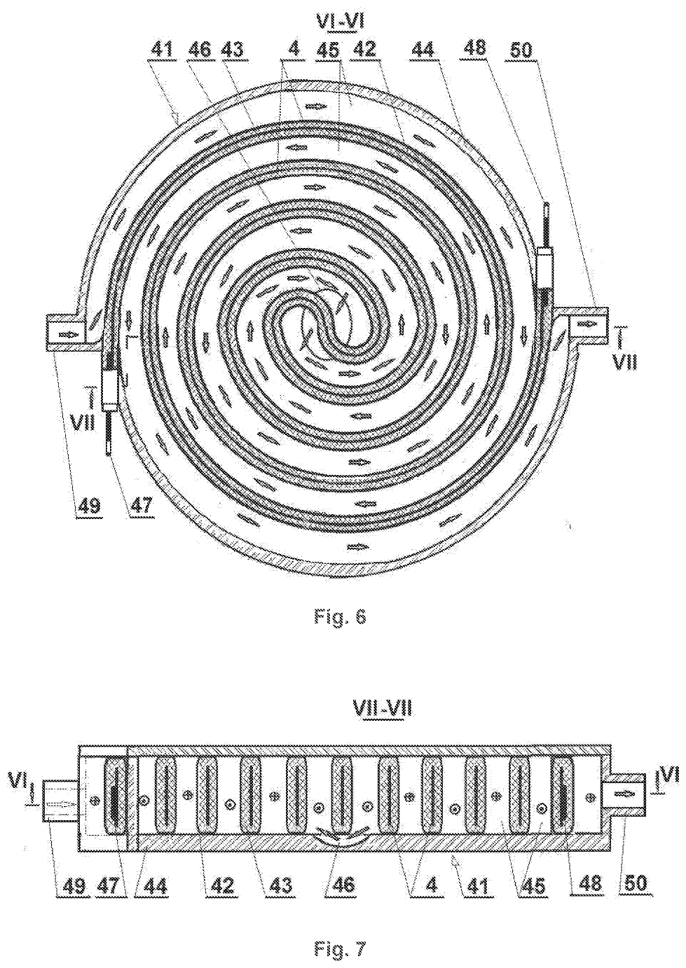

FIGS. 6 and 7 show a variant of an electric heater with a flat (disk) heating element 41 curved in the form of a double Archimedes spiral. The shell of the heating element 41 is formed from a flattened tube 42, inside which a spiral of thin resistive tape 4 is placed. The tape 4 has an insulating coating 43, made predominantly of heat-resistant fiberglass. The external and internal surface of the tape 4, respectively, forms the external and internal heat-radiating surface of the heater. The coils of the spiral shell 42 are pressed against the ends of the housing 44 with their short sides, and spiral gaps 45 for liquid flow are formed between adjacent wide sides of the coils of the tubular spiral 42. Under one of the turns in the central part of the spiral heating element, a passage 46 for the liquid flow is made. The ends of the resistive spiral 4 are connected to the contact cleats 47 and 48, which are placed outside the shell and used for the connection to the power source. Branch pipes 49 and 50, respectively, for the inlet and outlet of water are placed on the periphery of the housing 44 in front of the ends of the tubular spiral 42.

The FIG. 8 presents a variant of a two-tier electric heater with disk spiral heating elements 41A and 41B, side view. The front view of the two-tier electric heater is similar to that shown in FIG. 6. The heating elements 41a and 41b are placed in the housing 51 and are separated by an inter-level partition 52. The water outlet from the heating element 41a is connected to the water inlet to the heating element 41b by a connecting branch pipe 53.

The electric heater operates as follows.

The variant shown in FIG. 1 can be used as an effective instantaneous electric heater of a liquid under pressure. The voltage from the current source is supplied to the resistive tapes 4 of the cylindrical heating elements 1 and 2 only after the flow switch (not shown) is activated.

An electric current causes the heating of the tape spirals 4. All the heating energy is transferred to the water through a thin layer of protective heat-conducting enamel coating 5, therefore, heat loss is minimized. The cylindrical gaps 11 for the liquid flow formed on both sides of each heating element 1 and 2, provide, on the one hand, a uniform heating of the entire liquid flow, and on the other hand, a high throughput of the heater. Due to the presence of passages between the heating elements and the ends of the housing 10, the heated liquid sequentially flows around all their external and internal heat-radiating surfaces. This increases the contact time of the liquid flow with the heater and provides intensive sequential heat removal from the entire area of these heat-radiating surfaces. Moreover, in the cylindrical gap between the heating elements 1 and 2, the liquid is surrounded on all sides by heat-radiating surfaces and heats up even more. The presence of the central tube 14 further increases the contact time of the liquid flow with the heater.

The cylindrical heating element can also be formed by means of a spiral shell made of a flattened tube into which a thin resistive tape 4 with an insulating heat-resistant coating is pressed. In this case, the turns of the tubular spiral adjoin each other with their short sides. This expands the scope of application of such cylindrical heating elements in instantaneous water heaters, in accordance with the available technological capabilities.

The variant shown in FIG. 1 can also be effectively used in many immersed electric heating devices that are always filled with liquid, in particular such as, for example, accumulation boilers. In this case, the liquid passages should be provided from sides of the upper and lower ends of the heating elements. The liquid located between the heating elements and in the center of the heater is surrounded on all sides by a heat-radiating surface and thus heats up more. This causes convective movement and circulation of the liquid in the heater housing, which further intensifies its rapid heating.

If necessary (for example, for small volumes of liquid located in the heater housing), a variant of a heater containing one cylindrical heating element can be developed.

All this will expand the scope of such cylindrical heating elements and in storage water heaters.

The heater option shown in FIG. 2 and containing two pairs of cylindrical heating elements concentrically arranged between each other, is most effective for powerful instantaneous heaters. Such heaters can provide heating of large liquid flows to almost any desired temperature, without significantly increase in the heater dimensions.

Due to the sequential flow around of the liquid the external and the internal heat-radiating surfaces of all four heating elements, the contact time of the liquid flow with the heater is increased, and an intensive sequential heat harvest from the entire area of these heat-radiating surfaces also is ensured. The equality of the sum of the diameters of the connected pairs of cylindrical heating elements ensures the equality of their output powers. Moreover, by switching the connection between the pairs of heating elements 1a, 2a and 1b, 2b by means of contact leads, it is possible to control the total output power of the heater, the heating rate and the temperature of the liquid.

For three-phase electric networks, flow heaters containing at least three pairs of concentrically placed cylindrical heating elements can be made. Such heat-efficient water heaters, being compact, will provide almost any required performance.

A variant of a flat heater, presented in FIGS. 3 and 4, can be most effectively used in an instantaneous electric heater for a soft liquid (slightly mineralized) under pressure. The voltage from the current source is supplied to the resistive tape 4 of the heating element 21 only after the operation of the flow switch (not shown). An electric current causes heating of the tape 4. In this case, the resistive tape 4, stretched between the clamps 24, is in direct contact with water, which ensures maximum heat transfer. The heated liquid enters through the branch pipe 28 and is heated simultaneously in two wave-shaped gaps formed on both sides of the heat-radiating surfaces of the resistive tape 4. In this case, the liquid flow flowing along the entire wave-shaped contour of the resistive tape 4, sequentially gathers the heat from the entire area of the heat-radiating surfaces of the heating element 21 and exits through the branch pipe 29. Direct contact of the resistive tape with the water provides the maximum reduction in heat losses, as well as cost reduction of an electric heater manufacturing (since there are no costs for the insulation coating and the protective shell of the resistive tape).

A variant of the heater containing two tiers of flat heating elements, shown in FIG. 5, is most effective for powerful instantaneous heaters. Such heaters can provide heating of large liquid flows to almost any desired temperature, without significantly increase in the heater dimensions.

Due to the sequential flow around of the liquid along all the heat-emitting surfaces of both heating elements, the contact time of the liquid flow with the heater is increased and intensive sequential heat harvest from the entire area of these heat-radiating surfaces is ensured.

By switching the connection of the heating elements 21a and 21b by means of the contact cleats, the total output power of the heater, the heating speed and the liquid temperature can be adjusted.

For three-phase electrical networks, instantaneous heaters comprising at least three flat heating elements can be constructed. Such heat-efficient water heaters will provide practically any required performance, while being compact and having a low manufacturing cost.

The option of a disk spiral heater, shown in FIGS. 6 and 7, can most effectively be used in an instantaneous electric heater of a liquid, the working conditions in which require a protective shell for the resistive conductor. Its use is similar to the above option in FIGS. 3 and 4, which expands the scope of the proposed heating elements.

The voltage from the current source is supplied to the spiral tape 4 of the heating element 41 only after the flow switch (not shown) is activated. An electric current causes heating of the spiral tapes 4.

The liquid being heated enters through the branch pipe 49, heats up in the spiral gaps formed between adjacent coils of the heating spirals, and exits through the branch pipe 50. In this case, the liquid stream flowing along the contour of each coil of the spiral heater 41 performs sequential intensive heat harvest from the entire area of both sides of their heat-radiating surfaces. The passage 46 under the place turnabout of the heating spiral provides a sequential liquid flow along the heat-radiating surfaces of its two branches. This provides an increase in the contact time of the liquid flow with the heater and stronger heating of the liquid.

Disc spiral heaters can also be effectively used in many submerged electric heating devices that are always filled with liquid, in particular such as, kettles, boilers and washing machines. In this case, passages for liquid should be provided from sides of the upper and the lower ends of the heating elements. The liquid located between the heating elements and in the center of the heater is surrounded on all sides by a heat-emitting surface and heats up more strongly. This causes a convective movement and circulation of the liquid in the heater housing, which further intensifies its rapid heating.

A variant of the heater containing two tiers of flat spiral heating elements, shown in FIG. 8, is most effective for powerful instantaneous heaters. Such heaters can provide heating of large liquid flows to almost any required temperature, without significantly increasing in the dimensions of the heater.

Due to the sequential flow around of the liquid along all the heat-radiating surfaces of both heating elements, the contact time of the liquid flow with the heater is increased and intensive sequential heat harvest from the entire area of these heat-radiating surfaces is ensured. By switching the connection between the heating elements 41a and 41b by means of the contact cleats, the total output power of the heater, the heating rate and the liquid temperature can be adjusted.

For three-phase electrical networks, flow heaters comprising at least three flat spiral heating elements can be constructed. Such heat-efficient water heaters will provide almost any required performance, while being compact and having a low manufacturing cost.

### AREA OF USE OF THE INVENTION

The proposed electric heaters with heating elements made from a thin resistive tape can be used in most various water heating devices, as an effective replacement of the known electric heaters with a round resistive conductor.

The main area of use of the proposed electric heaters is a variety of instantaneous water heaters of almost any capacity.

An additional area of use of the proposed electric heaters is any accumulation water heaters (for example, electric boilers), as well as immersed water heaters (for example, kettles and washing machines).

Thus, the proposed electric heaters, with volumetric (cylindrical) and flat (sinusoidal and spiral) heating elements of a thin resistive tape, can be used in a wide variety of devices for heating liquids. Such heating elements, in comparison with analogues, have a large heat-radiating surface, provide greater heat-efficiency and power output, as well as optimize the operating temperature, minimize heating time and heat losses of the heater. The widespread use of the proposed electric heaters will provide significant electrical energy savings in the respective countries.

1. Electric water heater containing a resistive heating element with a resistive conductor, located inside the heater housing and submerged in water, characterized in that:
the area of the heat-radiating surface of the heating element is increased by making a resistive conductor from a flat resistive tape with a thin cross-section, the perimeter of which exceeds the perimeter of a round conductor of equal cross-sectional area, with both wide sides of the resistive tape forming heat-radiating surfaces, and the tape width exceeds its thickness, predominantly by more than ten times,
a heating element with a resistive tape is placed in the housing of the electric heater in such a way that on both sides of its heat-radiating surfaces, the adjacent gaps, predominantly slotted, are formed for the flow of the heated liquid,
the ratio between the width of the heat-radiating surface of the heating element and the slit size of each gap for the flow of the heated liquid is selected from the condition of ensuring such temperature pressure and thermal conductivity, at which the rate of the heat transfer to the heated liquid is close to the maximum.

2. Electric heater according to claim 1, characterized in that:
the heating element contains a thin resistive tape rolled in the form of a cylindrical spiral, and the wide sides of the resistive tape form, respectively, the external and internal heat-radiating surfaces of the formed cylindrical heating element,
the cylindrical heating element is placed in the electric heater housing in such a way, that cylindrical gaps for a liquid flow are formed with the side of its external and internal heat-radiating surfaces.

3. Electric heater according to claim 2, characterized in that the cylindrical spiral of a thin resistive tape is wound on a carcass made of a thin-walled cylindrical pipe, and has a coating, predominantly from enamel, that insulates it from the heated liquid.

4. Electric heater according to claim 2 or 3, characterized in that:
contains two cylindrical heating elements concentrically placed one in the other with the formation of cylindrical gaps for the liquid flow between them, as well as between the external heating element and the heater housing,
adjacent heating elements are pressed with their first ends to the opposite ends of the heater housing, and have passages for liquid flow between their second ends and adjacent ends of the heater housing,
the ends of the resistive tapes of the two heating elements from one side of the heater housing are connected to each other by means of a jumper isolated from the heated liquid, and the ends of the resistive tapes from the second side of the heater housing are connected to the contacts for connecting to a power source.

5. Electric heater according to claim 4, characterized in that:
it contains at least two pairs of concentrically placed cylindrical heating elements, moreover all cylindrical gaps for the liquid flow successively communicating with each other,
a pairs of interconnected cylindrical heating elements are selected from the condition of equality of the total dimensions of the diameters of the connected pairs of cylinders.

6. Electric heater according to claim 1, characterized in that:
the heating element contains a thin resistive tape curved in the shape of a sinusoid, mainly a rectangular sinusoid (meander), and the wide sides of the resistive tape form two heat-radiating surfaces of the formed heating element of a sinusoidal shape,
the electric heater's housing is made in the shape of a flat prism and is divided by partitions into longitudinal sections that have passages between each two adjacent sections for sequential passage of liquid through all sections,
the heating element is placed in sections of the heater housing in such a way, that its sinusoidal ends are pressed to the flat ends of the heater housing,
the sinusoidal gaps for the liquid flow are formed with on the sides of both heat-radiating surfaces of the heating element.

7. Electric heater according to claim 1, characterized in that:
the heating element contains a thin resistive tape, rolled in the shape of a flat spiral, predominantly in the form of a double Archimedes spiral, moreover the wide sides of the resistive tape form, respectively, the external and internal heat-radiating surfaces of the formed spiral heating element,
the electric heater housing is made in the shape of a disk, and the spiral heating element is placed in it in such a way, that the spiral ends of the heating element are pressed to the ends of the disk housing,
spiral gaps for the liquid flow are formed with the side of the external and internal heat-radiating surfaces of the spiral heating element,
a passage for a liquid flow is made in the central part of the disk housing, under the place turnabout of the twin spiral heating element.

8. Electric heater according to claim 6 or 7, characterized in that:
It contains at least two heating elements located in the heater housing on parallel tiers and separated from each other by partitions,
the gaps for the liquid flow are successively connected to each other by connecting the outlet branch pipe of one heating element to the inlet branch pipe of an adjacent heating element.

9. Electric heater according to claim 2, 6, 7 or 8, characterized in that:
the thin resistive tape has an elastic insulating coating, which is pressed together with it into a flattened tubular shell, and the cross section of the tubular shell has a shape close to that of the resistive tape.
